(19) United States
(12) Patent Application Publication
(10) Pub. No.: US 2008/0271384 A1
(43) Pub. Date: Nov. 6, 2008

(54) CONDITIONING TOOLS AND TECHNIQUES FOR CHEMICAL MECHANICAL PLANARIZATION

(75) Inventors: Thomas Puthanangady, Shrewsbury, MA (US); Taewook Hwang, Acton, MA (US); Srinivasan Ramanath, Holden, MA (US); Eric M. Schultz, Worcester, MA (US); J. Gary Baldoni, Norfolk, MA (US); Sergej-Tomislav Buljan, Acton, MA (US); Charles Dinh-Ngoc, Clinton, MA (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN CERAMICS & PLASTICS, INC., Worcester, MA (US)

(21) Appl. No.: 11/857,499

(22) Filed: Sep. 19, 2007

Related U.S. Application Data
(60) Provisional application No. 60/846,416, filed on Sep. 22, 2006.

(51) Int. Cl. C09K 3/14; B24D 3/06

(52) U.S. Cl. 51/309; 51/293

(57) ABSTRACT

Tools for conditioning chemical mechanical planarization (CMP) pads comprise a substrate with abrasive particles coupled to at least one surface. The tools can have various particle and bond configurations. For instance, abrasive particles may be bonded (e.g., brazed or other metal bond technique) to one side, or to front and back sides. Alternatively, abrasive particles are bonded to a front side, and filler particles coupled to a back side. The abrasive particles can form a pattern (e.g., hexagonal) and have particle sizes that are sufficiently small to penetrate pores of a CMP pad during conditioning, leading to fewer defects on wafers polished with the conditioned CMP pad. Grain bonding can be accomplished using brazing films, although other metal bonds may be used as well. Also, balanced bond material (e.g., braze on both sides) allows for low out-of-flatness value.

### RELATED APPLICATIONS

This application claims the benefit of U.S. Provisional Application No. 60/846,416, filed on Sep. 22, 2006. In addition, this application is related to U.S. application Ser. No. 11/229,440, filed Sep. 16, 2005. Each of these applications is incorporated herein by reference in its entirety.

### FIELD OF THE INVENTION

The present invention relates to abrasives technology, and more particularly, to tools and techniques for conditioning polishing pads such as CMP pads used in the microelectronics industry.

### BACKGROUND OF THE INVENTION

A pad conditioner is generally used to condition or dress polishing pads for polishing a variety of materials including semiconductor wafers, glasses, hard disc substrates, sapphire wafers and windows, and plastics. These polishing processes usually involve use of a polymeric pad and slurry containing a plurality of loose abrasive particles and other chemical additives to enhance removal process by both chemical and mechanical actions.

For example, an Integrated-Circuit (IC) fabrication process requires numerous manufacturing steps including mainly deposition, etching, patterning, cleaning, and removal processes. One of the removal processes in IC fabrication refers to chemical mechanical polishing or planarization (CMP) process. This CMP process is used to produce flat (planar) surfaces on wafers. Typically, polymer pads are used to polish, and during the process, the pads become glazed with polishing residues. As such, the glazed pad surfaces need to be conditioned to deliver stable polishing performance. Otherwise, process instability and deteriorated wafer surfaces generally result in cost increases.

There is a need, therefore, for pad conditioning tools and processes.

### SUMMARY OF THE INVENTION

One embodiment of the present invention is a tool for conditioning chemical mechanical planarization (CMP) pads. The tool includes a support member with at least two sides (e.g., front and back sides) and a plurality of abrasive particles, wherein the abrasive particles are coupled to at least one of the sides of the support member by a metal bond, and at least about 95% (by weight) of the abrasive particles have a particle size of less than about 85 micrometers. The tool has an abrasive particle concentration of greater than about 4000 abrasive particles/inch² (620 abrasive particles/centimeter²) and an inter-particle spacing so that substantially no abrasive particles are touching other abrasive particles (e.g., less than 5% by volume of abrasive particles are touching other abrasive particles). In some such cases, the abrasive particle concentration is greater than about 10000 abrasive particles/inch² (1550 abrasive particles/centimeter²). The tool may have an out-of-flatness, for example, of less than about 0.01 inches, and in some cases, less than about 0.002 inches. In one particular case, the support member is a stainless steel disk, and the abrasive particles are diamonds. In one such case, the metal bond is a brazing alloy, and the diamonds are brazed to the first side of the support member by the brazing alloy. In another such case, the diamonds are brazed to both the first side and the second side of the support member by the brazing alloy. In another such case, the diamonds are brazed only to the first side of the support member by the brazing alloy, and the second side of the support member has braze (no diamonds). In one such case, inert (with respect to the tool manufacturing process) filler particles are brazed to the second side. A number of such metal bond and abrasive particle configurations will be apparent in light of this disclosure. The braze alloy can be, for example, a braze film (e.g., braze tape or foil). In one particular case, the braze alloy includes a nickel alloy having a chromium amount of at least about 2% by weight. The abrasive grains may be positioned, for example, in the form of one or more patterns. Example abrasive grain patterns and sub-patterns include SARD™ patterns, hexagonal patterns, face centered cubic patterns, cubic patterns, rhombic patterns, spiral patterns, and random patterns. The inter-particle spacing may be substantially the same for all abrasive particles, but may also vary as will be apparent in light of this disclosure. Specific inter-particle spacings can be achieved, for example, by using an abrasive placement guide that has openings with a corresponding inter-opening spacing. An example placement guide is a brazing film (e.g., foil) that has a plurality of openings or perforations in the desired pattern. Such perforations may also be used to allow out-gassing of volatized adhesive during brazing, thereby reducing lift-up of the brazing film. In one example case, the metal bond may be braze tape or braze foil (precursor state), wherein the braze tape or braze foil has a pattern of openings, with each opening for holding a single abrasive particle therein, such that post-firing, the abrasive grains form a grain pattern substantially similar to the pattern of openings.

Another embodiment of the present invention provides a method for manufacturing a tool for conditioning a CMP pad. The method includes providing a support member having a first side and a second side (e.g., front side and back side that are substantially parallel to each other, although they need not be parallel). The method further includes coupling abrasive particles to at least one of the first and second sides of the support member with a metal bond, wherein at least 95% (by weight) of the abrasive particles have, independently, a particle size of less than about 85 micrometers. The tool is manufactured to have an abrasive particle concentration of greater than about 4000 abrasive particles/inch² (620 abrasive particles/centimeter²), and an inter-particle spacing so that substantially no abrasive particles are touching other abrasive particles. In one such case, the tool is manufactured to have an out-of-flatness of less than about 0.002 inches (50.8 micrometers). Coupling the abrasive particles to at least one of the sides of the support member with a metal bond may include, for example, electroplating, sintering, soldering, or brazing the abrasive particles to at least one of the sides of the support member. In one such case, coupling the abrasive particles comprises brazing the abrasive particles to at least one of the sides of the support member with a brazing alloy. Here, brazing includes bonding a brazing film to at least one of the sides of the support member, positioning abrasive particles on at least a portion of the brazing film to form a green part, and firing the green part (and subsequently cooling) the green part to thereby chemically bond the abrasive particles with the brazing alloy to the support member. The brazing film can be, for example, selected from the group consisting of braze tape, braze foil, braze tape with perforations, and braze foil with perforations. The brazing film may have a thickness, for instance, that is between about 1% and about 60% of the smallest particle size of the abrasive particles. Positioning the abrasive particles may include, for example, applying the abrasive particles to a plurality of openings in or on at least a portion of the brazing film, wherein each opening is configured to receive one of the abrasive particles. In one such case, openings form a pattern or sub-patterns (e.g., SARD™ pattern, hexagonal pattern, etc). Here, applying the abrasive particles to a plurality of openings in or on at least a portion of the brazing film may include, for example, applying a layer of adhesive to at least one portion of the brazing film, positioning a placement guide comprising at least a portion of the plurality of openings on the layer of adhesive, and contacting the abrasive particles with the adhesive through the openings. Alternatively, positioning the abrasive particles may include, for example, applying adhesive to at least a portion of the brazing film, and randomly distributing the abrasive particles on the adhesive. As will be apparent in light of this disclosure, coupling the abrasive particles to at least one of the sides of the support member may include brazing the abrasive particles to both the first side and second side of the support member with a brazing alloy. Alternatively, coupling the abrasive particles to at least one of the sides of the support member may include applying a brazing alloy to both the first and second sides of the support member, and brazing the abrasive particles to only the first side of the support member with the brazing alloy. In one such case, the method further includes brazing one or more inert filler particles to the second side of the support member with the brazing alloy.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a schematic cross section view of a CMP pad conditioning tool having a single layer of abrasive particles on the front side, in accordance with one embodiment of the present invention.

FIG. 2 is a schematic cross section view of a CMP pad conditioning tool having a single layer of abrasive particles brazed to the front side and a single layer of abrasive particles brazed to the back side of the tool, in accordance with another embodiment of the present invention.

FIG. 3 is a schematic cross section view of a CMP pad conditioning tool having a single layer of abrasive particles brazed to the front side and a layer of brazing alloy on the back side of the tool, in accordance with another embodiment of the present invention.

FIG. 4 is a top view of any one of the working surfaces of the CMP pad conditioning tools shown in FIG. 1, 2 or 3, having abrasive particles brazed to the support member such that the particles form a SARD™ pattern, in accordance with one embodiment of the present invention.

FIG. 5 is a top view of any one of the working surfaces of the CMP pad conditioning tools shown in FIG. 1, 2, or 3, having abrasive particles brazed to the support member such that the particles form a hexagonal pattern, in accordance with one embodiment of the present invention.

FIG. 6 is a schematic side view of a green part being fired in a furnace while being supported by a zirconia support to produce a double sided brazed pad conditioning tool, in accordance with one embodiment of the present invention.

### DETAILED DESCRIPTION OF THE INVENTION

Pad conditioning tools and techniques are disclosed, which can be used in a number of applications, such as conditioning a CMP polishing pad. During the conditioning process, it is not sufficient to simply maintain process stability by conditioning the glazed surface of the pad. The conditioner is responsible for generating pad texture or topography which greatly influences wafer surface quality. Formation of optimal pad texture requires an optimization of various conditioner manufacturing parameters such as abrasive size, distribution, shape, concentration, and height distribution. Inappropriate selection of a pad conditioner tool may result in a pad texture that produces micro-scratches on the polished workpiece surface, and can also increase dishing or erosion on the patterns formed on the workpiece.

In describing and claiming various embodiments of the present invention, the following terminology may be used:

As used herein, “out-of-flatness” is a measure that can be used to characterize a side of a tool for conditioning a polishing pad (such as a CMP pad), and generally refers to deviation from a true plane in a radial direction. In one example case, out-of-flatness is measured as the difference in height between a lowest measured point of a tool's side and a highest measured point of that side (using the same measuring technique at each point). The out-of-flatness of a tool for a conditioning CMP pad configured in accordance with an embodiment of the present invention may range, for example, from about 0.01 inches to as low as about 0 inches. The desired out-of-flatness may vary greatly from one application to the next, depending on desired performance criteria.

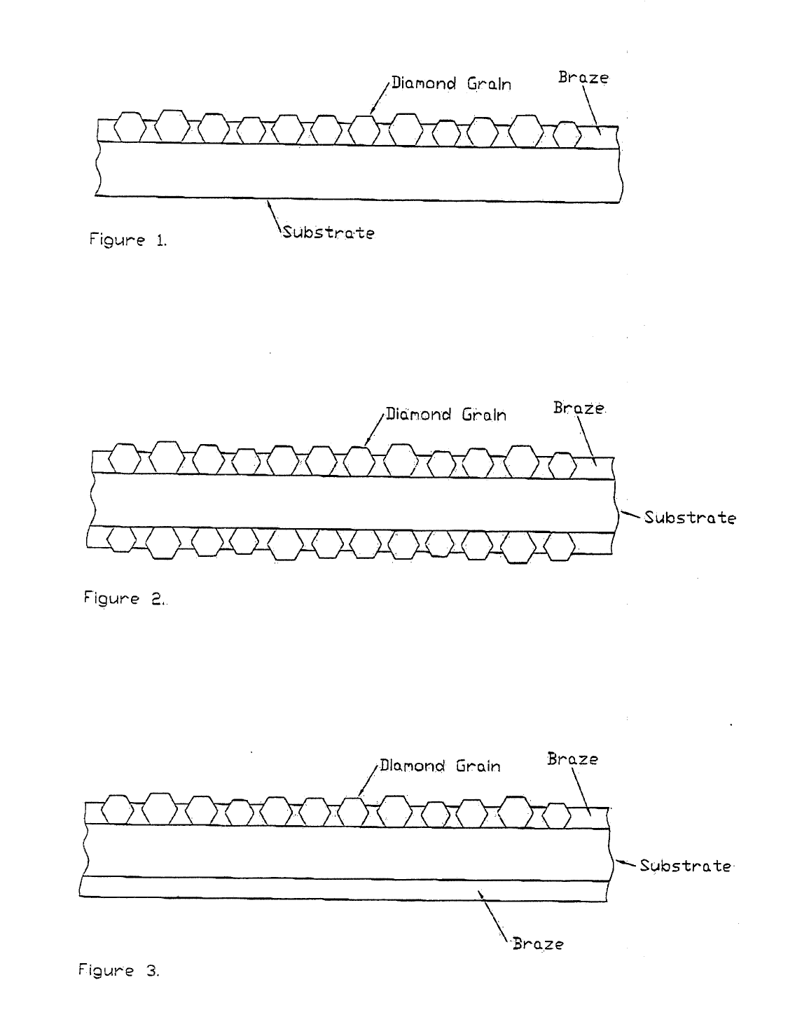

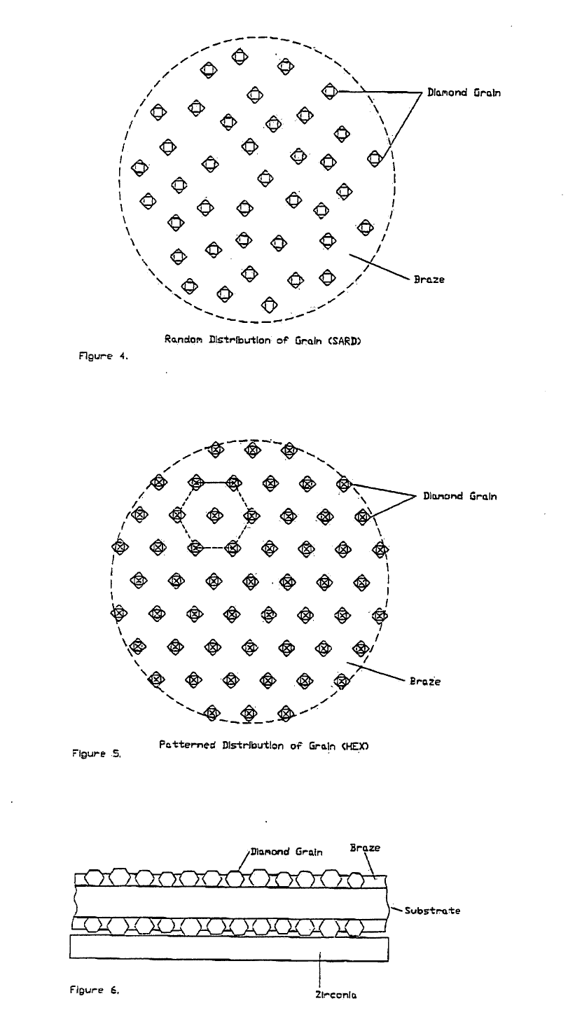

As used herein, “working surface” refers to a surface of a pad dresser and accordingly to a side of the corresponding support member that, during operation, faces toward, or comes in contact with a CMP pad or other such polishing pad. Abrasive particles are positioned on the working surface. FIGS. 1 and 3 illustrate pad conditioners that have one working surface, while FIG. 2 illustrates a pad conditioner that has two working surfaces (although both need not be used). Alternatively, both sides may have been coupled with abrasive particles to improve the out-of-flatness of the working surface.

As used herein, the “inter-particle spacing” of an abrasive particle refers to the minimum distance of the abrasive particle to its nearest neighboring abrasive particle, wherein “minimum distance” is the minimum length between any two points, one point being on the surface of the abrasive particle and the other point being on the surface of the neighboring abrasive particle.

As used herein, a “green part” refers to a part prior to being fired in a furnace.

Dressing Tool

FIG. 1 provides a schematic illustration of diamond grains that are brazed to one side of a support member, and FIG. 2 provides a schematic illustration of diamond grains that are brazed to both sides of a support member. A support member (also referred to herein as a preform or substrate) is the base portion of a tool for conditioning a polishing pad (e.g., CMP pad). The tool itself may be referred to, for example, as a “pad dresser” or “pad conditioner” or “conditioning tool”). In both FIGS. 1 and 2, the support member has two planar sides that are substantially parallel to each other, wherein one of the two sides can be referred to as a front side and the other side can be referred to as a back side. Other embodiments of the present invention may haves planar sides that are non-parallel.

The support member may be made, for example, of any material that substantially withstands the chemical and mechanical conditions during the process of conditioning of a CMP pad. Example materials from which the support member is made include metallic, ceramic, and thermoplastic materials, as well as mixtures thereof. As used herein, “metallic” includes any type of metal, metal alloy, or mixture thereof. Examples metallic materials that are suitable to form the support member include steel, iron, and stainless steel. In specific embodiments, the support member is made up of 304 stainless steel or 430 stainless steel. Furthermore, the support member may include one or more narrow slots extending along the entire surface of one or more of its sides. These slots may, for example, provide enhanced slurry access between the tool and pad (for debris removal), reduction of internal stress after firing (due to formation of non-contiguous brazed areas), and assist in out-gassing of volatized adhesive during brazing (or other thermal processing). These slots may be produced, for example, by slotting with a thin grinding wheel or tungsten carbide disk.

As can be seen, the abrasive particle in these example embodiments is diamond, although other suitable abrasive particles can be used as well. Other example abrasive particles include cubic boron nitride, seeded gel, quartz, and aluminum oxide. The abrasive type used will generally depend on the application at hand, and may include any hard crystalline substance as will be apparent in light of this disclosure. A plurality of abrasive particles refers to two or more abrasive particles. In general, the maximum number of abrasive particles that can be coupled to the support member depends on the particle size of the abrasive particles. The smaller the particle size the more abrasive particle can be coupled to the support member without touching each other. For example, the maximum number of abrasive particles can be in the tens-of-thousands (e.g., 240 thousand).

The size of abrasive particles (“particle size”) can be determined, for example, by sieve analysis or screening. For instance, an abrasive particle of particle size 65 to 75 micrometers will pass through 75 mesh (U.S. Sieve Series) and will not pass through 65 mesh (U.S. Sieve Series). Any particle size that allows a plurality of abrasive particles to be brazed to a side of a support member without any two of the abrasive particles being in contact is suitable, for example, particle sizes in the range from about 15 micrometers to about 350 micrometers. In one embodiment, the particle size is such that individual abrasive particles can penetrate the pores of a polymer CMP pad that is to be conditioned. As a result, the amount of slurry agglomerate that can collect in pad pores is reduced, leading to fewer and less severe defects on the polished wafers (or other workpiece).

The range of particle sizes will generally depend on factors such as the screening/selection technique employed and abrasive particle shapes (e.g., rounder grains tend to screen more accurately than elongated grains). The percentage (by weight) of abrasive particles being in a certain size range can be specified as well. For instance, and in accordance with one embodiment, at least 50% (by weight) of the abrasive particles have, independently, a particle size of less than about 85 micrometers. Depending on the screening techniques and control used to isolate abrasive particles in the desired size range, the percentage of certain sized abrasive particles (by weight) can be as high as 100%. For example, and in accordance with another particular embodiment, about 60% to 100% (by weight) of the abrasive particles have, independently, a particle size between about 65 micrometers and about 75 micrometers. In another particular case, about 50% to 100% of the abrasive particles have, independently, a particle size between about 45 micrometers and 85 micrometers. In another particular case, about 50% to 100% of the abrasive particles have, independently, a particle size between about micrometers and about 50 micrometers. Numerous abrasive particle size schemes using properly screened or otherwise selected fine grit abrasive (e.g., diamond) will be apparent in light of this disclosure, and the present invention is not intended to be limited to any particular one.

The abrasive grains may be positioned, for example, in the form of one or more patterns. A pattern may comprise one or more sub-patterns. Each pattern has objects that define a border and accordingly a shape of the pattern. Any pattern shape is acceptable in various embodiments of the present invention. In some embodiments, the shape of the pattern is adjusted to be similar to the shape of the side of the support member (e.g., if the support member has a circular side, the pattern has a circular shape). Example abrasive grain patterns and sub-patterns include SARD™ patterns, hexagonal patterns, face centered cubic patterns, cubic patterns, rhombic patterns, and spiral patterns. A SARD™ pattern refers to a self-avoiding abrasive grain array, and example such pattern is shown in FIG. 4. Additional details of how to implement such a pattern are disclosed in the previously incorporated U.S. patent application Ser. No. 11/229,440, titled “Abrasive Tools Made with a Self-Avoiding Abrasive Grain Array.” A hexagonal pattern refers to an arrangement of objects in which each object that does not define the border of the pattern has six objects surrounding it in equal distance. An example hexagonal pattern is shown in FIG. 5. Random abrasive grain patterns (e.g., where grains are randomly distributed on the substrate) can be used as well. Such patterns include pseudo-random and chaotic or fractal patterns. One or more sub-patterns as described above and one or more random patterns may be combined to form mixed patterns. Numerous abrasive grain pattern and sub-pattern schemes will be apparent in light of this disclosure.

The inter-particle spacing may be substantially the same for all abrasive particles (e.g., such as the case with the example hexagonal pattern of FIG. 5). Alternatively, or in addition to, abrasive particles may have different inter-particle spacings (e.g., as may be the case with a random pattern). Any inter-particle spacing is acceptable, as long as the abrasive particles are not in contact with each other and the desired concentration is provided. Specific inter-particle spacings can be achieved, for example, by using a placement foil (or other suitable guide) that comprises openings with a corresponding inter-opening spacing. The inter-particle spacing can be, for instance, between about 10 and 480 micrometers. In one such specific embodiment, the inter-particle spacing is between about 10 and 180 micrometers. A placement guide essentially acts as a tool to aid the positioning of abrasive particles onto one or more sides of the support member. It comprises a plurality of openings, wherein each opening is adapted (sized and shaped) to allow one abrasive particle to fit through or otherwise sit therein. In one example embodiment, the openings are circular, although other suitable shapes can be used. The openings in the placement guide effectively form a pattern as previously discussed, thereby leading to the positioned abrasive particles exhibiting substantially the same pattern and concentration. Although there may be some movement of particles during the firing process, the resulting grain pattern mimics the pattern of openings in the placement guide. The placement guide can be, for example, a braze film such as braze tape or braze foil. Alternatively, the placement guide can be in addition to the braze tape or foil, where the guide is adhered to an underlying layer of braze tape or foil. A number of braze film and guide schemes will be apparent in light of this disclosure.

The abrasive particles can be coupled (bonded or otherwise fixed) to the support member using processes such as brazing, soldering, sintering, and electroplating. In one example embodiment, the abrasive particles are coupled to the support member using electroplating. Example metals that can be used in the electroplating process to couple the abrasive particles to the support member include nickel, chromium, gold, palladium, silver, and the like. In another embodiment, the abrasive particles are brazed to the support member. In one such case, the braze contains a nickel alloy having a chromium amount of at least about 2% by weight. Specific examples of commercially available Nickel-Chromium brazes that can be used in accordance with some embodiments of the present invention include Wall Colmonoy LM, Vitta 1777, and Lucas Milhaupt Hi Temp 820. Note that such brazes can be used to form braze films as well. Other suitable brazes (whether commercially available or customized) will be apparent in light of this disclosure.

In some such embodiments, the braze is in the form of a brazing film, which is a film, sheet or layer of brazing alloy that may have perforations and may have adhesive on one or both of its sides. Brazing films include brazing tapes or brazing foils. Brazing tape may include, for example, an organic binder that holds the metal alloy powder in place and has an adhesive backing on one or both sides, and is commercially available with relatively small thicknesses (e.g., about 25 micrometers or less). On the other hand, brazing foil can be amorphous, ductile, and does not contain organic binder. Brazing foils are also commercially available with relatively small and consistent thicknesses (e.g., variations of about ±2.5 micrometers). Compared with braze paste, brazing tape and brazing foil have an advantage that they produce a consistent braze allowance (thickness of braze). Compared with braze paste and brazing tape, brazing foil melts more uniformly and quickly, so as to allow for higher productivity in the manufacture of CMP dressers. A number of bond schemes will be apparent in light of this disclosure. The perforations previously noted refer to a plurality of openings or gaps in a brazing film. The perforations can be used to allow out-gassing of volatized adhesive during brazing, thereby preventing lift-up of the brazing film, and may further be used to establish desired grain patterns. Recall that such perforations may also be used to facilitate desired grain patterns and concentrations. Perforations may have any form, including but not limited to circular, rectangular, oval, and triangular. Perforations may, for example, be made by laser or photo-chemical machining, or any other suitable process.

FIG. 3 provides a schematic illustration of diamond grains that are brazed to one side of a support member, with the other side of the support member having only a layer of braze (no abrasive particles). The previous discussion with reference to FIGS. 1 and 2, and with respect to details regarding the support member, abrasive particles and bond types, is equally applicable here. Coupling of the same bonding material to each of the two sides of the support member, independently, with or without particles, allows for smaller out-of-flatness values for the tool, particularly, for those having thin support members. In the example of FIG. 3, braze is the bonding agent. In an alternative embodiment, abrasive particles are coupled to one side of the support member, and inert (with respect to the tool manufacturing process) filler particles are coupled to the other side. Examples of inert fillers include oxides, nitrides, carbides, borides, and the like. Specific example filler particles include zirconia, alumina, and silica. Such inert filler particles can be used, for example, to match the coefficient of thermal expansion of braze-filler combination to that of braze-abrasive combination to inhibit out-of-flatness. Likewise, such inert fillers can be used to prevent sticking of braze to the plate or refractory on which the green tool rests during thermal processing, so as to inhibit out-of-flatness. In addition, such inert fillers may improve wear resistance and can operate as an abrasive, if so desired. One specific embodiment of the present invention is a dressing tool having an out-of-flatness of less than about 0.002 inches. Other embodiments may have even lower out-of-flatness specifications (e.g., less than about 0.001 inches).

The abrasive particles bonded or otherwise coupled to the support member may have, for example, between about 1% and about 60% of each particle's surface exposed (protruding from the brazing alloy or other bond material), and substantially all of the surface that is not so exposed is in contact with the bond material. In one particular embodiment, each of the abrasive particles has about 40% to 60% of its surface exposed, so as to provide a single layer of bonded grains having a relatively uniform protruding height distribution. Variations in the protruding height distribution will depend on factors such as the size and shape of individual grains, how each grain is set within the bond, and bond thickness. As a general rule of thumb, the thickness of post-firing braze film is about one half its pre-firing thickness (precursor state thickness). Similar guides apply to other metal bond types. Thus, given a desired amount of the exposed surface for each abrasive particle and the average size of the abrasive particles, an appropriate braze film thickness can be selected. For instance, given relatively round abrasive particles having an average particle size of about 100 micrometers and a desired exposure of about 60%, a braze film having a pre-firing thickness of about 80 micrometers could be used. After firing, that braze film thickness will be about 40 micrometers, thereby leaving about 60 micrometers of each grain exposed (which is about 60% of the grain surface in this example). With a range of particle sizes, this calculation can be done, for example, from the perspective of the smallest sized particle within the given range.

Thus, one detailed example embodiment of the present invention is a tool for conditioning a CMP pad that includes a stainless steel disk having a front side and a back side; a brazing alloy; and a plurality of diamonds. The diamonds are brazed to both the front and back sides of the stainless steel disk by the brazing alloy, at least about 95% (by weight) of the diamonds having a particle size of less than about 85 micrometers. Alternatively, the back side of the stainless steel disk has only the brazing alloy (i.e., no diamonds). Alternatively, the back side of the stainless steel disk has the brazing alloy and an inert filler particle (but again, no diamonds). The tool may be further characterized by having an out-of-flatness about 0.002 inches or less. In one specific such embodiment, at least about 95% (by weight) of the diamonds have, independently, a particle size between about 65 micrometers and about 85 micrometers. The majority (more than 50% by weight) of these abrasive particles are about 75 micrometers or less. The abrasive particles form a pattern (e.g., hexagonal or SARD™ pattern, or combination thereof). As will be appreciated in light of this disclosure, the pattern of fine abrasive particles determines the placement of each particle, as well as the overall concentration of abrasive particles. The result is a pad conditioner capable of generating a pad topography that tends to improve wafer surface quality.

Manufacturing Techniques

Another embodiment of the present invention includes a method of manufacturing a tool for conditioning a CMP pad.

In one such embodiment, the method includes the following steps: providing a support member comprising a front side and a back side, wherein the front side and back side are substantially parallel to each other; and coupling abrasive particles to at least one of the sides of the support member, wherein at least about 50% (by weight) of the abrasive particles have, independently, a particle size of less than about 85 micrometers. In one specific case, the tool is manufactured to have an out-of-flatness of less than about 0.002 inches, or even less than about 0.001 inches, as previously discussed. The support member can be, for example, a stainless steel disk and the abrasive particles can be diamonds (or other suitable abrasive particles or combination of such particles). Discussion herein regarding details of various tool embodiments, including abrasive type, size, and weight percentage of the abrasive particle size, is equally applicable here.

In one particular case, the step of coupling abrasive particles to the support member includes brazing abrasive particles with brazing alloy to at least one of the sides of the support member. Here, the step of brazing abrasive particles may include, for example: bonding a brazing film to at least one of the sides of the support member to form a layer of braze on each of the sides to which the brazing material was applied; positioning abrasive particles on each of the layers of braze to form a green part; and firing the green part to melt all layers of braze followed by cooling the green part, to chemically bond the abrasive particles with brazing alloy to the support member. The brazing film can be, for instance, braze tape, braze foil, braze tape with perforations, or braze foil with perforations, as previously discussed. In one such specific case, the brazing film is brazing foil, the support member is a stainless steel disk, the abrasive particles are diamonds, and at least about 50% (by weight) of the diamonds have, independently, a particle size between about 65 micrometers and about 75 micrometers. The step of positioning abrasive particles on each of the layers of braze may include, for example: applying adhesive to all layers of braze; positioning a placement foil having a plurality of openings on each layer of adhesive; and contacting the abrasive particles with the adhesive through the openings. In one such case, the openings form a pattern (e.g., such as a SARD™ pattern, face centered cubic pattern, cubic pattern, hexagonal pattern, rhombic pattern, spiral pattern, random pattern, and combinations of such patterns). As previously explained, a pattern may include a number of sub-patterns. Further recall that the pattern of openings can be integrated into a brazing film as previously discussed.

Further recall that abrasive particles and braze may each be applied to one or both sides of the support member. In one example case, the step of bonding a brazing film includes bonding a brazing film to both sides of the support member, and the step of positioning includes positioning abrasive particles on both sides (e.g., front and back sides) to form the green part. Alternatively, the step of bonding a brazing film includes bonding a brazing film to both sides of the support member, and the step of positioning includes positioning abrasive particles only on one side (e.g., front side) to form the green part. Here, the positioning step may further include positioning inert filler particles on the other side (e.g., back side) to form the green part. As previously explained, bonding a brazing film (or other suitable braze) on both sides of the support member (regardless of whether both sides have an abrasive) is one technique that allows for a low out-of-flatness value (e.g., less than 0.001 inches), particularly for support members that are relatively thin. A similar benefit can be had through the use of inert filler particles. Nonetheless, the step of bonding a brazing film may alternatively include bonding a brazing film to only one side (e.g., front side) of the support member, and the step of positioning includes positioning abrasive particles on that one side to form the green part. In such a one-sided embodiment, the out-of-flatness value may be higher relative to embodiments having balanced bond material and particle schemes.

Various specific embodiments of the present invention are now described by the following examples:

### EXAMPLE 1

FEPA D76 200/230 mesh diamonds (source: Element Six Ltd) were subsieved to −85 micrometers +65 micrometers. 3.6183 gram of diamonds were sieved using the sieves (U.S. Sieve Series) shown below. The following distribution of diamonds on or through sieves of the given mesh was obtained:

| Sieve | Grams | % |
|---|---|---|
| On 116 | 0 | 0 |
| On 85 | 0.1042 | 2.88 |
| On 75 | 1.2697 | 35.09 |
| On 65 | 2.1359 | 59.03 |
| Through 65 | 0.1085 | 3.00 |
| Through 49 | 0 | 0 |
| | 3.6183 | 100.00 |

Accordingly, 35.09% by total weight of sieved diamonds went through the sieve of mesh 85 and 59.03 by total weight of sieved diamonds stayed on the sieve of mesh 65. All other diamonds were discarded. Accordingly, 37.97% by weight of the retained diamonds had a particle size of less than 85 micrometers and more than 75 micrometers, and 62.03% by weight of the retained diamonds had a particle size of less than 75 micrometers and more than 65 micrometers. These diamonds were used in the manufacture of CMP pad conditioning tools, in accordance with various embodiments of the present invention.

### EXAMPLE 2

A CMP pad conditioning tool with diamonds as abrasive particles on one side was manufactured according to the following steps:

1) a 304 stainless steel preform of 4″ diameter and 0.250″ thickness was cleaned by ultrasonic degreasing, dry blasting, and solvent wiping to make it receptive to brazing;

2) 0.003″ thick Vitta 4777 Braze tape (Vitta Corporation, Bethel Conn.) was applied to the readied surface by hand and was leveled using an acrylic roller;

3) K4-2-4 adhesive (Vitta Corporation, Bethel Conn.) was applied, by brushing, onto the exposed surface of the braze tape to make it tacky (the part was then allowed to sit for a finite period (e.g., about 15 minutes) to allow for a suitable degree of tackiness);

4) a 0.002″ thick foil (source: TechEtch, Plymouth Mass.) with a hexagonal array of openings (0.004″ to 0.005″ diameter) was designed to allow precise placement of single grit abrasives, and the foil was mounted in a suitable rigid frame to provide a foil screen;

5) the framed foil screen was placed in contact with the tacky surface using a screen printing apparatus;

6) abrasive particles were applied to the top of the framed foil and abrasives were pushed into the designed holes (only one abrasive per each opening), and extra abrasive particles not captured in an opening were removed with a soft tipped paint brush (the abrasive particles were the FEPA D76 diamond abrasive particles subsieved to −85 micrometers +65 micrometers as described in Example 1);

7) the framed foil was lifted up leaving a controlled pattern of abrasive particles on the tacky braze surface;

8) the green part was fired under vacuum (<1 mm Hg) in a furnace at 1020° C. for 20 minutes; and

9) the braze melted, and upon cooling, chemically bonded the diamond to the steel preform.

The end result was an abrasive product whereby a single layer of precisely placed non-contiguous abrasive particles was bonded to a steel preform with a predefined thickness of braze. Variations on this embodiment include one embodiment where abrasive particles are brazed onto both sides of the preform, another embodiment where abrasive particles were brazed onto one side and only braze was brazed onto the other side, and another embodiment where abrasive particles were brazed onto one side and inert filler particles (e.g., zirconia) were brazed onto the other side.

### EXAMPLE 3

BNi2 (American Welders Association designation) braze tape (Vitta Corporation, Bethel, Conn.) was applied to a four inch diameter CMP dresser preform (304 stainless steel) and a roller was used to remove any air bubbles. The tape thickness was 0.007±0.0001 inches. Vitta adhesive (Vitta Corporation, Bethel, Conn.) was applied to the tape surface to make it tacky and diamond (FEPA 100/120 mesh subsieved to −155 micrometers +139 micrometers) was placed on the tacky braze surface using a hexagonal stencil. The coated preform was oven dried at 75° C. overnight, and then fired under vacuum (<1 mm Hg) in a furnace at 1020° C. for 20 minutes. After furnacing, a CMP dresser with an out-of-flatness of less than about 0.002 inch was produced. It will be appreciated that the same example can be made using the diamond from Example 1.

### EXAMPLE 4

A braze paste was prepared by blending 2181 gm of Nicrobraze LM braze powder (Wall Colmonoy Corporation, Madison Heights, Mich.) powder (<44 μm) with 510 gm of a fugitive liquid binder, Vitta Braze-Gel (Vitta Corporation, Bethel, Conn.) and 90 gm of Tripropylene Glycol in a stainless steel container until a uniform paste was formed. The paste was applied to a four inch diameter CMP dresser preform (304 stainless steel) using a doctor blade with a 0.008 inch braze allowance. The coated preform was air dried, and then fired under vacuum (<1 mm Hg) in a furnace at 1020° C. for 20 minutes. The resultant cooled furnaced part consisted of the preform with a coating of dense, non porous solidified braze. Vitta adhesive (Vitta Corporation, Bethel, Conn.) was applied to the densified braze surface to make it tacky and diamond (100/120 mesh) was placed on the tacky surface using a hexagonal stencil. The part was subsequently re-fired under the same conditions initially used. The braze re-melted and upon cooling bonded the diamond to the preform. After the second furnacing, this dresser was indistinguishable from a counterpart that was fabricated by applying diamond to a green braze tacky surface with a hexagonal stencil. It will be appreciated that the same examples can be made using the diamond from Example 1.

### EXAMPLE 5

Following the identification of a ceramic material such as zirconia, that is not wetted by nickel-chrome braze, it was feasible to apply the braze with diamond (FEPA 100/120 mesh subsieved to −155 micrometers+139 micrometers) on both sides of a stainless steel back and furnace it. In particular, two 0.0625″ thick 430 stainless steel preforms were obtained. Braze was applied to one side of the first preform and to both sides of the second preform. Diamonds were placed in a desired pattern. Both green parts were furnaced at 1020° C. The resulting tool with braze on only one side was severely distorted. In particular, the tool was cupped, where the center was 0.068 inches below the edges. In contrast, the tool with double-side braze had an out-of-flatness of about 0.008 inches, a large reduction relative to the single-side brazed part.

### EXAMPLE 6

Field evaluation of various SARD™ dressers were conducted. The dressers evaluated are shown in the Table 1. As can be seen, the SARD™ dressers were compared to a benchmark. The benchmark was a Nickel electroplated product. Both diamond and filler are bonded to the substrate with the Ni plating. As is known, electroplating processes can use fillers to effectively control diamond concentrations to less than full (i.e., filler takes up space so that diamond is not tacked to the entire preform surface). Although the benchmark dresser includes some 70 μm diamond, the grain size ranges significantly, with some diamonds over 100 μm in size. In addition, the diamonds were placed onto the substrate in a non-controlled manner thereby providing undesirable results, such as particle stacking (e.g., where one diamond is plated on top of another diamond, or where a filler particle is plated on top of a diamond) and/or excessive particle touching (e.g., greater than 5% by volume of abrasive particles touching other abrasive particles). Such uncontrolled inter-particle spacing is problematic in pad conditioning applications, as two small but touching particles effectively operate together as one large particle that behaves differently (e.g., cuts deeper and wider than its neighboring particles) leading to an inappropriate pad texture.

TABLE 1

| | | Relative Diamond Concentration |
|---|---|---|
| Dresser | Description | (%) |
| Benchmark | Standard | 100 |
| | | (about 86000 diamonds and filler total, |
| | | placed in uncontrolled fashion) |
| | | (about 28963 diamonds/inch²) |
| SGA-05-067 | Single sided, brazed, SARD ™ | 10 |
| | pattern with diamond (FEPA | (about 8600 diamonds total) |
| | 100/120 mesh subsieved | (about 2896 diamonds/inch²) |
| | to −155 μm + 139 μm, | |
| | 4 diamonds per mm²) | |
| SGA-05-184 | Single sided, brazed, random | 77 |
| | pattern with diamond (FEPA D76 | (about 66220 diamonds total) |
| | 200/230 mesh, subsieved to | (about 22301 diamonds/inch²) |
| | −85 μm + 65 μm) | |
| SGA-05-187 | Single sided, brazed, SARD ™ | 16 |
| | pattern with diamond (FEPA | (about 13760 diamonds total) |
| | 120/140 mesh subsieved | (about 4634 diamonds/inch²) |
| | to −139 μm + 107 μm | |

The SARD™ dresser SGA-05-067 has an abrasive grain concentration that is about 90% lower than the benchmark. The SARD™ dressers SGA-05-184 and 187 were designed to determine the effect of diamond concentration on wafer defectivity, with SGA-05-184 employing diamonds of Example 1. SGA-05-184 has a concentration that is the closest to the particle concentration of the benchmark, but without yielding the particle-touching-particle and stacking issues of the benchmark. Other particle concentrations will be apparent in light of this disclosure, such as dressers having four to twenty-five thousand abrasive particles per square inch (e.g., 13000 diamonds/inch²), or higher. The test results, shown below in Table 2, indicate that defectivity, especially for particles at 0.3 μm and above, can be significantly reduced at higher diamond concentrations where the diamonds are selectively placed (as in a SARD or hexagonal pattern, in accordance with an embodiment of the present invention). Higher diamond concentrations can be achieved, for example, with smaller diamond sizes. Note that MRR stands for material removal rate, and WIWNU stands for Within-Wafer-Nonuniformity, each of which are relatively similar for the dressers tested.

TABLE 2

| | Relative | Relative | Relative Particle |
|---|---|---|---|
| Dresser | MRR | WIWNU | Count (@0.3 μm) |
| Benchmark | 1.0 | 1.0 | 1.0 |
| SGA-05-067 | 1.1 | 1.0 | 1.6 |
| SGA-05-184 | 1.1 | 0.8 | 0.9 |
| SGA-05-187 | 1.1 | 1.2 | 0.9 |

Based on these test results, various dressers configured in accordance with an embodiment of the present invention were designed. In particular, and due to higher packing efficiency, a hexagonal array (such as the one previously discussed with reference to FIG. 5) produces more cutting points per unit area compared to a SARD™ array. Thus, in order to maximize the diamond concentration, dressers having two diamond arrangements were designed. The first is a true hexagonal array which yields about 47,000 cutting points using 70 μm diamond (per Example 1). The second is a SARD™ arrangement based on a hexagonal array with the grain center points randomized.

### EXAMPLE 7

CMP conditioners for CMOS (Complementary Metal Oxide Semiconductor) Oxide/Tungsten CMP processes were tested. The test results are shown in the Tables 3 and 4 below. The SGA-05-68 SARD™ conditioner (SGA_old), having a grain concentration of about 3005 diamonds per square inch, showed more defects even though it outperformed the benchmark dresser (having about 28963 diamonds per square inch) with higher removal rate and better uniformity.

As can be seen in Tables 3 and 4, Oxide and Tungsten conditioners with smaller diamond sizes and accordingly higher diamond concentrations per square inch outperformed the benchmark dressers with higher removal rate, better uniformity, and comparable defect. The benchmark II dresser noted in Table 4 is a diamond CVD coated dresser having a low concentration of about 50 micron diamonds (less than 2000 diamonds/inch²).

TABLE 3
Oxide Testing Results

| | | | | | | | Blanket TEOS (16K) | |
|---|---|---|---|---|---|---|---|---|
| | | | | | | | | Particle |
| | | | | | | | WIWNU | Count |
| | | | Conc. | | | MRR | (%) < | (@0.3 um) < |
| Dresser | ID | Bond | (#/inch²) | Size (um) | Pattern | (A/min) | 7% | 75 |
| Benchmark | Standard | Electroplated | 28963 | 76 | Random | 6759 | 6.1 | 41 |
| SGA_old | SGA-05-68 | Brazed | 3005 | 151 | SARD ™ | 7522 | 5.2 | 269 |
| SGA_new | SGA-05-256 | Brazed | 17834 | FEPA D76 | Hex | 7693 | 3.0 | 20 |
| | | | | 200/230 | | | | |
| | | | | mesh | | | | |
| | | | | subsieved to | | | | |
| | | | | −85 μm | | | | |
| | | | | +65 μm | | | | |

TABLE 4
Tungsten Testing Results

| | | | | | | Blanket W | | Blanket TEOS | Patterned |
|---|---|---|---|---|---|---|---|---|---|
| | | | | | | (4.5K) | | (16K) | wafer |
| | | | Conc. | Size | | MRR | WIWNU | PC(@0.5 um) < | PC(@0.5 um) < |
| Conditioner | ID | Bond | (#/inch²) | (um) | Pattern | (A/min) | (%) < 12% | 125 | 50 |
| Benchmark | Standard | Diamond | 1911 | “50” | Random | 4200 | 7.0 | 60 | ~20 |
| II | | CVD coated | | | | | | | |
| SGA | SGA-05- | Electroplated | 23885 | FEPA D76 | Random | 4757 | 2.6 | 69 | 20 |
| | 265 | | | 200/230 | | | | | |
| | | | | mesh | | | | | |
| | | | | subsieved to | | | | | |
| | | | | −85 μm | | | | | |
| | | | | +65 μm | | | | | |

Thus, and in accordance with one embodiment of the present invention, a CMP dresser having fine abrasive particles in a relatively high concentration (e.g., greater than 4000 abrasive particles/inch²) and with the abrasive particles having a minimum inter-particle spacing (e.g., no abrasive particles are touching other abrasive particles), yields desirable performance in conditioning CMP pads. In one specific case, the inter-particle spacing is such that less than 2% by volume of the abrasive particles are touching other abrasive particles, while in another specific case, less than 1% abrasive particles are touching other abrasive particles. Higher volume percentage of touching grains (e.g., 5% to 10% by volume) may be allowed, depending on demands of the particular application.

### EXAMPLE 8

The conditioner SG-05-265 (Part Geometry: 2″ diameter×0.150″ thickness; Substrate: 430 stainless steel; diamond as described in Example 1) was manufactured according to the following procedure:

1) Parts are sufficiently cleaned to ensure the plating surface is free of contaminants or oxides that could inhibit good adhesion of nickel plating;

2) The parts are then selectively masked with tapes, liquid stop-offs, or non-conductive solid barriers to obtain plating in desired areas only;

3) Proper electrical contacts are made to the conditioner;

4) Parts are submersed horizontally in the nickel plating solution, sometimes with the aid of specially prepared baskets;

5) An abundance of diamonds are placed in direct contact with the surface to be diamond plated (the diamonds are normally held in place by gravity);

6) Nickel metal builds up around the first layer of diamonds in contact with the surface, lightly tacking them to the substrate;

7) Diamonds not sufficiently tacked are removed from the tool and all remaining diamonds are removed from the plating bath; and

8) The part is placed back into the plating solution for further metal encapsulation around the diamond. The metal bond is allowed to build up to a desired height past the equator or midpoint of the diamond so that sufficient mechanical locking of the diamond is achieved on the steel body.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1. A tool for conditioning a chemical mechanical planarization (CMP) pad comprising:
a support member having a first side and a second side; and
a plurality of abrasive particles, coupled to at least one of the first and second sides of the support member by a metal bond, and at least 95% (by weight) of the abrasive particles have, independently, a particle size of less than about 85 micrometers;
wherein the tool has an abrasive particle concentration of greater than about 4000 abrasive particles/inch² (620 abrasive particles/centimeter²), an inter-particle spacing so that substantially no abrasive particles are touching other abrasive particles, and a plurality of narrow slots extending along the surface of at least one of the first and second sides.

2. (canceled)

3. The tool of claim 1 wherein at least 50% (by weight) of the abrasive particles have, independently, a particle size between about 15 micrometers and about 50 micrometers.

4. (canceled)

5. (canceled)

6. (canceled)

7. (canceled)

8. (canceled)

9. The tool of claim 1 wherein the abrasive particles are brazed to the support member with a brazing alloy, and between about 1% and about 60% of the surface of any one of the abrasive particles is exposed and substantially all of the surface that is not so exposed is in contact with the brazing alloy.

10. The tool of claim 1 wherein substantially all the abrasive particles have, independently, an inter-particle spacing between about 10 and about 480 micrometers.

11. The tool of claim 10 wherein the inter-particle spacing is between about 10 and about 180 micrometers.

12. (canceled)

13. (canceled)

14. The tool of claim 1 wherein the abrasive particles include at least one member selected from the group consisting of diamond, cubic boron nitride, seeded gel and aluminum oxide, and the support member has a shape selected from the group consisting of circular shaped disk, cube, cuboid, bar, and oval shaped disk.

15. (canceled)

16. The tool of claim 1 wherein the abrasive particles are coupled to the first side and the second side of the support member.

17. The tool of claim 1 wherein the abrasive particles are coupled to the first side of the support member by the metal bond, and the second side of the support member has the metal bond thereon but no abrasive particles.

18. The tool of claim 17 wherein a plurality of inert filler particles are coupled to the second side of the support member by the metal bond.

19. (canceled)

20. (canceled)

21. (canceled)

22. (canceled)

23. A tool for conditioning a chemical mechanical planarization (CMP) pad comprising:
a metallic substrate having a first side and a second side;
a brazing alloy; and
a plurality of diamonds brazed to at least one of the first side and second side of the metallic substrate by the brazing alloy, at least 95% (by weight) of the diamonds having a particle size of less than about 85 micrometers;
wherein the tool has an abrasive particle concentration of greater than about 4000 abrasive particles/inch² (620 abrasive particles/centimeter²), an inter-particle spacing so that less than 5% by volume of the abrasive particles are touching other abrasive particles, and a plurality of narrow slots extending along the surface of at least one of the first and second sides.

24. (canceled)

25. (canceled)

26. (canceled)

27. (canceled)

28. The tool of claim 23 wherein the brazing alloy has a precursor state of braze tape or braze foil.

29. The tool of claim 28 wherein the braze tape or braze foil has a pattern of openings therein, with each opening for holding a single diamond therein, such that post-firing, the abrasive grains form a grain pattern substantially similar to the pattern of openings, wherein the grain pattern comprises at least one sub-pattern of the group consisting of SARD™ pattern, face centered cubic pattern, cubic pattern, hexagonal pattern, rhombic pattern, spiral pattern and random pattern.

30. (canceled)

31. The tool of claim 23 wherein the support member comprises at least one member of the group consisting of metallic material, ceramic material, and thermoplastic material.

32. (canceled)

33. (canceled)

34. A method for manufacturing a tool for conditioning a chemical mechanical planarization (CMP) pad comprising the steps of:
providing a support member having a first side and a second side; and
coupling abrasive particles to at least one of the first and second sides of the support member with a metal bond, and at least 95% (by weight) of the abrasive particles have, independently, a particle size of less than about 85 micrometers;
wherein the tool is manufactured to have an abrasive particle concentration of greater than about 4000 abrasive particles/inch² (620 abrasive particles/centimeter²), an inter-particle spacing so that substantially no abrasive particles are touching other abrasive particles, and a plurality of narrow slots extending along the surface of at least one of the first and second sides.

35. (canceled)

36. The method of claim 34 wherein coupling the abrasive particles to at least one of the sides of the support member with a metal bond comprises brazing the abrasive particles to at least one of the sides of the support member with a brazing alloy, the brazing comprising:
bonding a brazing film to at least one of the sides of the support member;
positioning abrasive particles on at least a portion of the brazing film to form a green part; and
firing the green part and subsequently cooling the green part to thereby chemically bond the abrasive particles with the brazing alloy to the support member;
wherein the brazing film is at least one member selected from the group consisting of braze tape, braze foil, braze tape with perforations, and braze foil with perforations.

37. The method of claim 36 wherein positioning the abrasive particles comprises:
applying the abrasive particles to a plurality of openings in or on at least a portion of the brazing film, wherein each opening is configured to receive one of the abrasive particles;
wherein the openings form a desired grain pattern and allow for out-gassing during brazing.

38. (canceled)

39. (canceled)

40. (canceled)

41. The method of claim 34 wherein coupling the abrasive particles to at least one of the sides of the support member comprises:
applying a brazing alloy to both the first and second sides of the support member; and
brazing the abrasive particles to only the first side of the support member with the brazing alloy.

42. The method of claim 41 further comprising:
brazing one or more inert filler particles to the first side of the support member with the brazing alloy.

43. The method of claim 34 wherein coupling the abrasive particles to at least one of the sides of the support member with a metal bond comprises:
applying the abrasive particles to a plurality of openings on at least one of the sides of the support member, wherein each opening is configured to receive one of the abrasive particles;
wherein the openings form a desired grain pattern.

44. (canceled)

45. (canceled)

46. The method of claim 1 wherein the plurality of narrow slots extend along the entirety of the surface.
